(19) United States
(12) Patent Application Publication
(10) Pub. No.: US 2004/0154500 A1
(43) Pub. Date: Aug. 12, 2004

(54) High pressure smudging device

(76) Inventors: Alain Richard, Paris (FR); Francis Samuel, Paris (FR); Philippe Legorjus, Treillieres (FR); Jean-Paul Perret, Domessin (FR); Jacques Saunier, Montjean sur Loir (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/479,422

(22) PCT Filed: Jul. 25, 2002
(86) PCT No.: PCT/EP02/08278

(30) Foreign Application Priority Data
Jul. 25, 2001 (FR) 01/09906

(51) Int. Cl. E05G 1/00

(52) U.S. Cl. 109/25

(57) ABSTRACT

The invention relates to a device for spoiling articles, the device comprising:

a compartment (30) for containing a spoiling or marking or destruction fluid or liquid (34) and ejection means (32) for ejecting said fluid or said liquid out from its compartment;

means (24, 26) for receiving a first cartridge (28) of compressed gas, means (27) for piercing or opening said cartridge, and means (26) for imparting relative displacement between the first cartridge and said piercing or opening means in order to move them towards each other; and

means (42) connecting said ejection means to said piercing or opening means.

### TECHNICAL FIELD AND PRIOR ART

The present invention relates to a device for spoiling or destroying articles of value, such as papers or confidential documents or bank notes or bills placed inside a box or container such as a transport case or a safe.

The invention also relates to a device enabling a fluid or a liquid to be projected effectively onto such articles, in order to destroy them or to make them unusable.

The invention also relates to a secure device for transporting such articles.

The invention also relates to a structure or device for containing articles of value, such as paper money or confidential documents, and enabling said articles to be destroyed, marked, or spoilt effectively, should that be necessary, for example in the event of theft or a non-authorized attempt at opening.

Systems are known that enable such destruction or spoiling to be obtained. However, those known systems do not as a general rule enable the box to operate while it is in any position, thus making them less effective.

In addition, they are often associated with external mechanisms that can interfere with the spoiling or destruction process.

Another problem lies in the structure of the receptacle containing the articles, and more particularly in the means which are placed in the receptacle and which enable a liquid to be projected for the purpose of destroying or spoiling the article in question. Such means are generally not very effective, and often do not make it possible to destroy or spoil all of the articles contained in the receptacle. This applies in particular when the articles are in the from of a bundle of documents or bank notes or bills. It is then necessary for the documents to be placed facing the projection device in order for them to be spoilt relatively effectively.

The performance of known devices for spoiling or destroying valuables placed inside the box is therefore limited.

There thus arises a problem of finding a novel device for marking or spoiling or destroying articles placed inside a box or a container.

There is also the problem of finding a device that enables articles to be marked, spoilt or destroyed while the device is in any position and without using an external mechanism.

There is also the problem of finding a novel device for projecting a fluid or a liquid enabling articles to be marked or spoilt or destroyed effectively.

### SUMMARY OF THE INVENTION

The invention firstly provides a device for spoiling or marking or destroying articles, the device comprising:

a compartment, or a first compartment, for containing a fluid or a liquid, and ejection means for ejecting said fluid or said liquid out from its compartment;

means, or a second compartment, for receiving a first cartridge of compressed gas, means for piercing or opening said cartridge, and means for imparting relative displacement of the first cartridge and said piercing or opening means in order to bring them closer together; and

means connecting said ejection means and said piercing or opening means, or connecting said first compartment and said second compartment, and serving to introduce said compressed gas from the first cartridge into said first compartment.

Such a device enables the fluid or liquid to be ejected effectively, and in particular while the device is in any position.

In an embodiment, said ejection means comprise a piston capable of moving in the compartment or the first compartment for containing the fluid or the liquid.

The means for imparting relative displacement between the first cartridge of compressed gas and said piercing or opening means comprise, for example, a piston which pushes the first cartridge.

A second cartridge of compressed gas may also be provided, together with means, e.g. a solenoid valve, for controlling the opening of said second cartridge, and means for directing a gas from said second cartridge towards the piston for displacing the first cartridge.

The second cartridge contains a gas at an initial pressure that may lie in the range 5 bars to 20 bars, while the first cartridge contains a compressed gas having an initial pressure lying in the range 50 bars to 300 bars.

Opening of the first cartridge is thus triggered effectively, and the pressure therein is sufficient for ensuring that the liquid or fluid contained in the first compartment is ejected quickly.

In another aspect, the device further comprises a compartment for receiving an article and means for directing the fluid or the liquid to said compartment.

Means for spraying the fluid or the liquid such as one or more strips enable said fluid or liquid to be distributed towards the articles.

The invention also provides a method of marking or spoiling or destroying articles that are to be spoilt or destroyed, the method comprising the following steps:

piercing or opening a first cartridge of compressed gas and directing at least a fraction of the flow of compressed gas leaving the cartridge towards means for ejecting a fluid or a liquid; and

directing the ejected fluid or liquid towards said articles to be spoilt or destroyed.

The method may be implemented using a spoiling device having a first compartment and a second compartment. Relative displacement may be imparted between a first cartridge of compressed gas and means for piercing or opening said cartridge, so as to move them towards each other. The gas leaving the cartridge can then be directed towards the first compartment, and the means for ejecting fluid or liquid can then be moved under drive from the compressed gas.

The invention also provides a device for receiving or transporting articles, the device comprising:

a compartment for receiving articles;

a feed channel for directing a fluid or a liquid towards the inside of said compartment; and

means for projecting or spraying the liquid into the inside of the compartment, said means comprising at least one panel provided with projection or spray holes connected to the feed channel.

Such a device is very effective in directing a fluid or a liquid, in particular a destroying, marking, or spoiling fluid or liquid towards articles to be destroyed or spoilt.

The invention also provides a secure device for transporting articles, the device comprising a device for receiving articles as described above, for example, together with means in accordance with the invention and as described above for marking or spoiling or destroying said articles.

### BRIEF DESCRIPTION OF THE FIGURES

FIGS. 1 to 4 show an embodiment of a device of the invention, and various steps in the operation of such a device;

FIG. 5 shows a case for transporting articles of value;

FIGS. 6 to 7 relate to various aspects of a device for projecting liquid; and

FIG. 8 shows another case for transporting articles of value.

### DETAILED DESCRIPTION OF EMBODIMENTS OF THE INVENTION

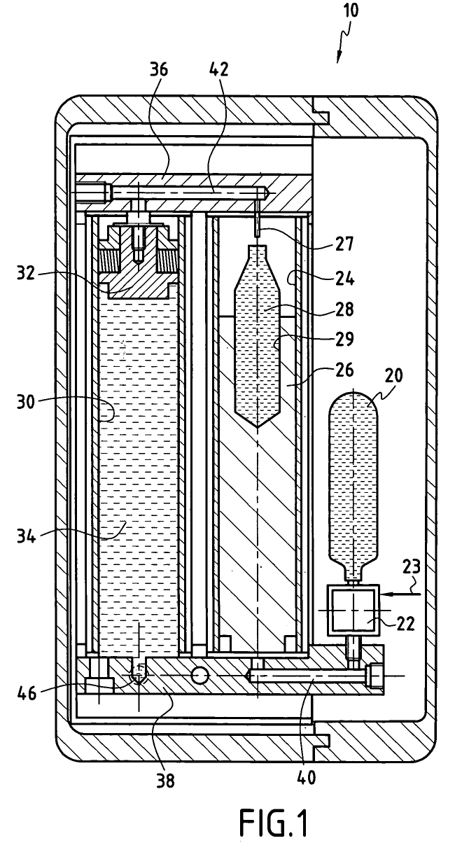

FIG. 1 shows an assembly enabling a liquid 34 to be projected for the purpose, for example, of enabling said liquid to destroy articles contained in a receptacle, which receptacle may itself be contained in a safe or in a transport case or device.

The assembly comprises a chamber or compartment 30 for containing a spoiling or marking or destruction liquid 34.

Means such as a piston 32 enable the liquid to be ejected from the compartment.

These means are movable under drive from a compressed gas expanding, the gas coming from a cartridge 28 which is held in a decompression chamber 24. When the gas is released from the cartridge, it propagates along a duct 42 connecting said chamber to the compartment 30.

The chamber 30 (referred to as a “decompression” chamber) is thus provided with communication with the chamber 24.

The compressed gas enables the means 32 to be set into motion (a piston or a wiper piston) in order to push out or eject the destruction or spoiling liquid 34 contained in the chamber 30.

The liquid 34 can then be ejected, e.g. via an outlet valve 46, into a reception box or a box containing valuables such as bank notes or bills.

Means 26 for holding a cartridge 28 of compressed gas are mounted in the decompression chamber 24.

The gas in the cartridge 28 is compressed to a “high” pressure, i.e. a pressure lying in the range a few tens to a few hundreds of bars, e.g. 50 bars to 300 bars, for example 200 bars. By way of example, this gas is air.

In an embodiment, the holding means 26 comprise a piston provided with an opening 29 for positioning a cartridge such as the cartridge 28.

Means 27 (e.g. a hollow needle) for opening for piercing the cartridge 28 are also provided in the decompression chamber 24.

Relative displacement between the two elements constituted by the cartridge 28 and the piercing means 27, causing these two elements to move towards each other, leads to the cartridge 28 being opened and to the gas contained therein being released.

In an embodiment, the needle 27 is mounted in a fixed position in the chamber 24 while the means 26 are capable of moving in translation in said chamber 24.

An embodiment of means for moving the means 26 is described below.

These means comprise a cartridge 20 of gas (e.g. air) which is compared to a “low” pressure, of the order of a few bars or tens of bars, for example in the range 5 bars to 30 bars, or in the range 5 bars to 15 bars, e.g. 8 bars.

This cartridge is closed by means for opening it in controlled manner, e.g. a solenoid valve 22. These means are activated by an external signal 23, e.g. coming from an attempt to open a box containing valuables (e.g. bank notes or bills).

On the means 22 opening, the gas in the cartridge 20 propagates along a duct 40 to the compartment 24 and pushes the piston 26. The cartridge 28 is thus advanced towards the needle 27.

The two chambers 24 and 30 are closed by end plates 36 and 38 which may also contain the flow ducts 40, 42.

A method of projecting a liquid contained in the chamber 30 comprises the following stages as shown in FIGS. 1-4, by way of example.

In a first stage (FIG. 1), the various members of the system are at rest. The cartridges 20, 28 are in the positions shown in FIG. 1, and each of them is filled with a gas at a pressure as indicated above.

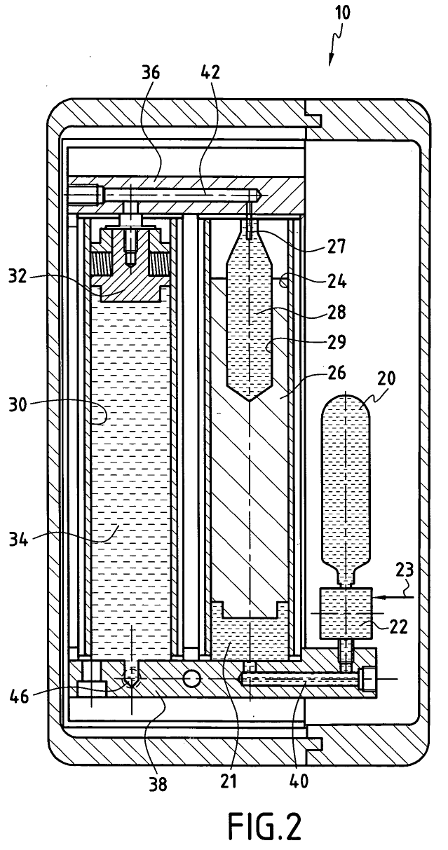

In a second stage (FIG. 2), the means 22 are triggered (said means being constituted, for example, by a solenoid valve that is excited by an electric signal), and the compressed gas (e.g. at 10 bars) contained in the cartridge 20 expands and pushes against the piston 26. This gas occupies the volume that is given reference 21 in FIG. 2. The hollow needle 27 which is in a fixed position in the end plate 36 at the end of the cylinder 24 then punctures the cartridge 28 held by the piston 26.

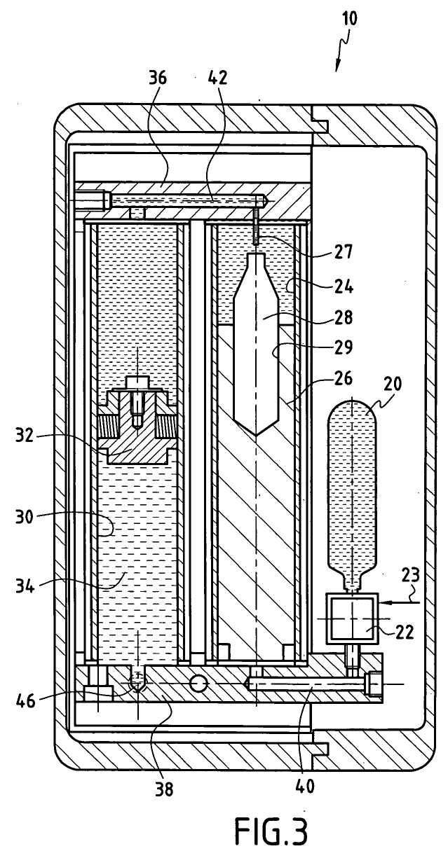

In a third stage (FIG. 3) the compressed gas 29 (e.g. at 200 bars) contained in the cartridge 28 expands and pushes the piston 32 which is fitted, for example, with a wiper seal, thereby expelling the liquid 34 contained in the cylinder 30 towards the outlet tube or valve 46.

The liquid 34 expelled via the valve 46 is diffused into the compartment containing the valuables.

The compressed air that remains in the cartridge 28 may possibly slide along grooves inside the cylinder 30 thus enabling any residual liquid situated in the chamber 30 to be expelled.

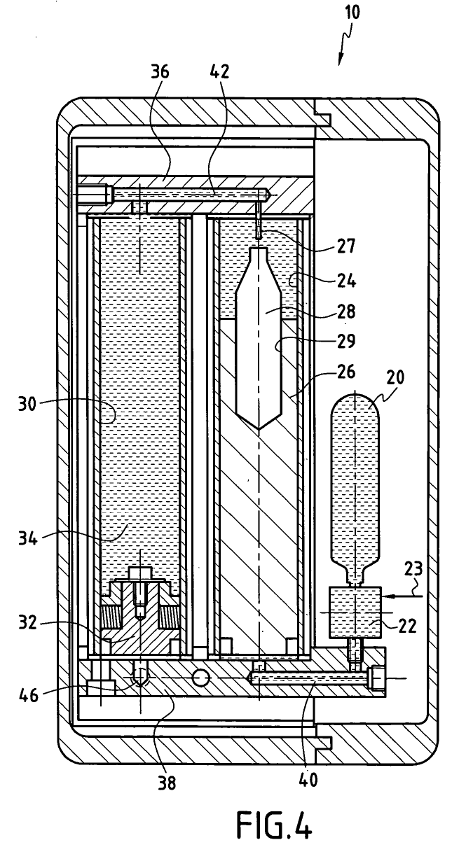

The initial pressure of the gas contained in the cartridge 29 is preferably such that the expanding compressed gas pushes back the piston 26 towards its rest position (FIG. 4).

This enables the supply of compressed gas 20 to be refilled with the gas that was contained in the volume 21. The gas that is pushed back into the cartridge 20 remains held therein, e.g. by means of a check valve in the solenoid valve.

After the liquid has been projected, the tank 30 is refilled and the compressed air cartridge 28 is replaced. The device is then operational once more.

The dimensions and the capacity of the device are functions of the quantity of liquid required for spoiling the volume of valuables placed inside the leaktight box and also on the percentage spoiling that is desired. By way of example, 25 centiliters (cl) of ink suffice for spoiling twenty banded bundles of 100 bank notes or bills each.

The fluid or liquid used in the compartment 30 may be a fluid or a liquid for spoiling or marking or destroying the protected articles of value. It may be an ink, for example, or indeed any type of liquid capable of making the articles of value that are protected in this way unusable or capable of destroying them, for example it may be an acid liquid. It may also be water. Pellets of a substance that is soluble in water and that is harmful to the articles may also be disposed in the vicinity of said articles. It is thus possible to use flakes of ink distributed over the articles in question so as to be put into solution in the water that is projected by the device 10 when the mechanism is triggered.

The above-described device occupies a small volume, i.e. it is compact. In addition, it operates regardless of its position.

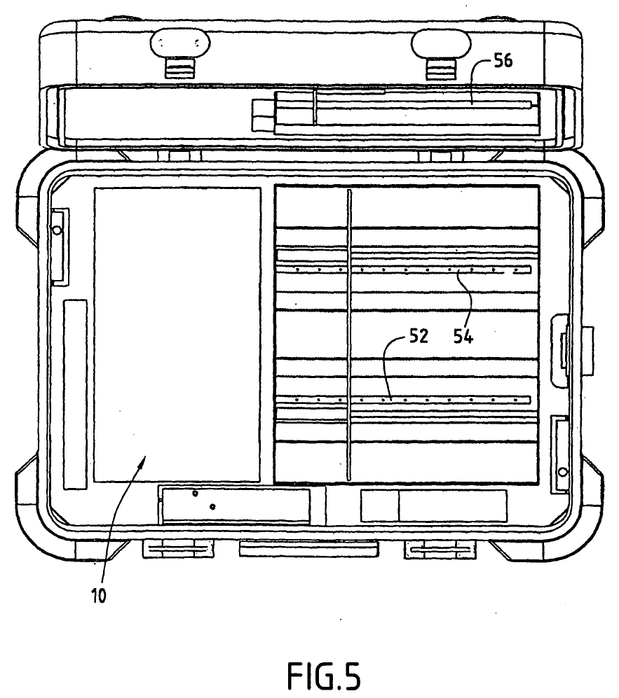

This device for projecting liquid can be used in a transport device of the type shown in FIG. 5 (a case shown in its open position and seen from above), which case contains both an assembly 10 as described above with reference to FIGS. 1 to 4 and also a compartment 50 in which bank notes or bills or documents or articles of value can be placed or enclosed. In this compartment there are disposed one or more strips 52, 54 for projecting the spoiling liquid and fed from the duct or valve 46.

A cover 56 situated in the top portion of the transport device serves to close the compartment 50 in leaktight manner.

The system of strips 52, 54 nevertheless presents the drawback of requiring the bank notes or bills (or documents or articles) to be placed accurately facing the strips in order to achieve a satisfactory degree of spoiling. Should the notes or bills or articles become scattered or distributed other than in their initial position during transit, the spoiling process can become ineffective or limited.

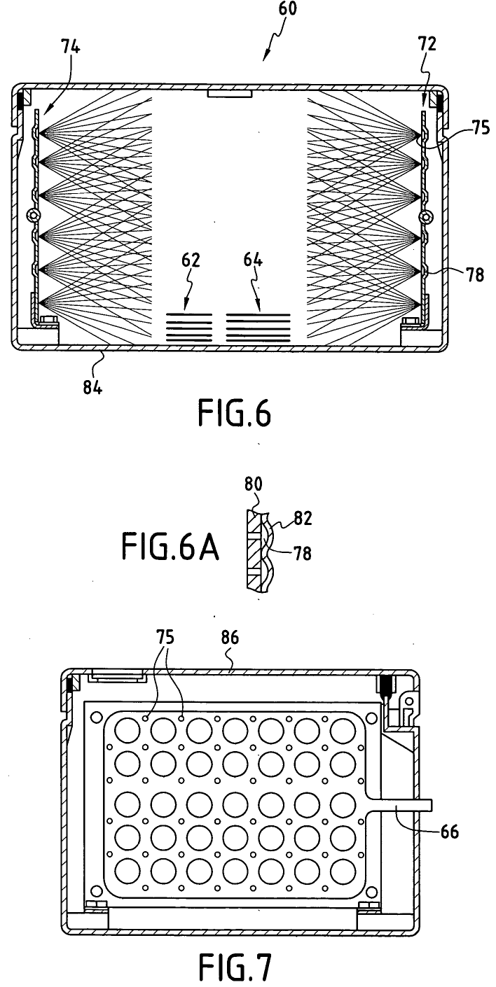

FIG. 6 shows another embodiment of the leaktight box or compartment 60 suitable for receiving the articles, and in particular valuables such as bank notes or bills 62, 64 and capable of overcoming the above drawbacks.

Such a box has a feed channel 66 for introducing a fluid or a liquid from the outside to the inside of the compartment, and means for projecting or spraying this fluid or liquid inside the compartment.

These projection or spray means comprise one or more panels 72, 74 having fluid projection or spray means 75 such as projection or spray holes pierced in the panels. Means 78 for feeding a fluid for projecting or spraying enable said fluid to be directed towards the means 75.

In FIG. 6, there can be seen two panels. It is equally possible to have a single panel or more than two, e.g. three or four. The or each panel is configured and/or dimensioned so that the jets coming from the spray means cover all of the space or the volume that might be occupied by bank notes or bills or documents or articles to be spoilt or destroyed. For example, the panels are disposed in such a manner that the jets cover the entire section of the inside of the compartment 60, as shown in FIG. 6.

In an embodiment, shown in FIG. 6A, each panel 72, 74 is made of two plates 80, 82 which are shaped and assembled together, e.g. by being welded together, so as to form an array of feed pipes or channels 78.

A container 84, e.g. made of plastics material, of dimensions suitable for receiving the valuables 62, 64 contains the panel(s) 72, 74 enabling the spoiling or destruction fluid to be distributed.

A preferably transparent cover 86 serves to close the receptacle in leaktight manner.

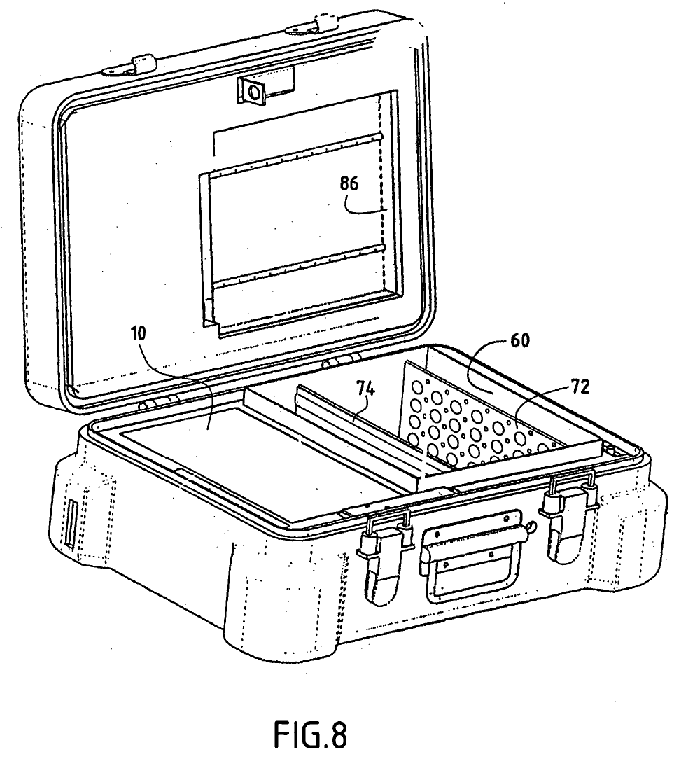

The device 60 as a whole can also be incorporated in a case as shown in FIG. 8, with the cover 86 possibly being incorporated in the top portion of the case.

The device may also be incorporated in a safe.

Pipework connects the compartment to a tank of spoiling or destruction liquid, e.g. a tank having the structure described above with reference to FIGS. 1 to 4.

In an embodiment, two panels 72, 74 are provided facing each other inside the leaktight box, each of these panels being provided with 40 holes so as to enable 80 jets of ink under pressure to be directed towards the valuables (bundles of bank notes or bills) contained therein.

It is also possible to use the device of FIGS. 6 and 7 in combination with a device for feeding any fluid or liquid, of the type that makes use of compressed gas, thus enabling the fluid or liquid to be expelled.

In any event, the destruction or spoiling means can be triggered on detecting an unauthorized attempt at opening the container which contains the protected valuables.

Means are provided for detecting such an unauthorized attempt at opening or breaking into the container. These means may be means such as sensors which deliver a signal representing any normal or abnormal change in some physical magnitude.

For example, the inside walls of the container may be provided with electrical means forming a circuit when the container is in a closed state, this circuit being broken when an attempt is made to break in. The inside walls of the container may be covered, for example, in an array of electrical conductors. In a normal, closed state of the container, current flows normally in the array or the conductors and a set value of current is detected by current detection means. when the circuit is opened, the current ceases to flow and a change in current is perceived, thereby triggering the destruction or spoiling mechanism, e.g. by acting on the means 22 of FIG. 1.

The invention applies to the field of safe transportation of articles, such as cash (in particular bank notes or bills) and/or checks and/or precious or confidential documents.

The invention applies in general to transporting any materials or documents or information needing to be transported with some degree of safety from one point to another or one person to another, and for one reason or another.

It also applies to surveillance of static devices such as safes containing articles or documents of value or bank notes or bills, or indeed to automatic cash dispensers.

1. A device for spoiling articles, the device comprising:
a compartment (30) for containing a fluid (34), and ejection means (32) for ejecting the fluid out from its compartment;
means (24, 26) for receiving a first cartridge (28) of compressed gas, means (27) for piercing or opening said cartridge, and means (26) for imparting relative displacement of the first cartridge and said piercing or opening means so as to move them towards each other; and
means (42) connecting said ejection means with said piercing or opening means.

2. A device according to claim 1, said ejection means (32) comprising a piston capable of moving in the compartment (30) for containing the fluid.

3. A device according to claim 1 or claim 2, the means for imparting relative displacement between the first cartridge (28) of compressed gas and said piercing and opening means (27) comprising a piston which pushes the first cartridge.

4. A device according to claim 3, comprising means (22) for controlling opening or a second cartridge (20) of compressed gas, and means (40) for directing a gas from said second cartridge towards the piston, enabling the first cartridge (28) to be moved.

5. A device according to claim 4, the means (22) for controlling opening of the second cartridge (20) comprising a solenoid valve.

6. A device according to claim 3, 4, or 5, including a second cartridge (20) of compressed gas at a pressure lying in the range 5 bars to 20 bars.

7. A device according to any preceding claim, said first cartridge (28) containing gas compressed to a pressure lying in the range 50 bars to 300 bars.

8. A device according to any preceding claim, further including a compartment (50, 60) for receiving an article (62, 64) and means (66) for directing the fluid to said compartment.

9. A device according to claim 8, the compartment further including means (52, 54, 72, 74) for spraying the fluid inside the compartment.

10. A device according to claim 9, the spray means comprising at least one panel (72, 74) provided with spray holes (75) connected to the means (66) for directing the fluid to the compartment.

11. A device according to claim 10, each panel comprising two plates (80, 82) assembled together and forming a fluid flow channel (78) between them.

12. A device according to any one of claims 8 to 11, said compartment being made of leakproof material.

13. A device according to any preceding claim, the compartment (30) for containing a fluid containing water or ink or an acid liquid.

14. A method of spoiling articles to be spoilt or destroyed, the method comprising the following steps:
piercing or opening a first cartridge (28) of compressed gas, and directing at least a fraction of the flow of compressed gas leaving the cartridge to means (32) for ejecting a fluid (34); and
directing the ejected fluid to said articles to be spoilt or destroyed.

15. A method according to claim 14, further including a step of imparting relative displacement between the first cartridge (28) of compressed gas and means (27) for piercing or opening said cartridge, so as to move them towards each other.

16. A method according to claim 15, including a step of opening a second cartridge (20) of compressed gas to move means (26) supporting said first cartridge (28).

17. A method according to the preceding claim, the gas contained in the second cartridge being at a pressure lying in the range 5 bars to 30 bars.

18. A method according to claim 16 or claim 17, a fraction of the gas in the first cartridge enabling at least a portion of the gas from the second cartridge to be reinserted into the second cartridge.

19. A method according to any one of claims 14 to 18, the gas contained in the first cartridge being at a pressure lying in the range 50 bars to 300 bars.

20. A method according to any one of claims 14 to 19, the fluid being water or ink or an acid liquid capable of attacking the articles.

21. A method according to any one of claims 14 to 19, pellets of a substance soluble in said fluid and harmful for the articles being disposed in the vicinity of the articles.

22. A device for safe transport of articles, including a device according to any one of claims 1 to 13 together with:
a compartment (60) for receiving articles;
a feed channel (66) for directing a fluid to the inside of said compartment; and
means for projecting or spraying fluid inside the compartment, said means comprising at least one panel (72, 74) provided with spray holes (75) connected to the feed channel.

23. A device according to claim 22, at least one of the panels being configured or dimensioned in such a manner that the jets coming from the projection or spray holes cover the entire space or the entire volume that can be occupied by articles in the compartment.

24. A device according to claim 22 or claim 23, the compartment being a leaktight compartment.

25. A device according to any one of claims 22 to 24, at lest a portion (86) of the compartment being made of a transparent material.

26. A device according to any one of claims 22 to 25, each panel being provided with means (78) for bringing the fluid to the projection or spray holes.

27. A device according to claim 26, at least one of the panels comprising two plates (80, 82) shaped and assembled together in such a manner as to form a feed channel (78).
